(19) United States
(12) Patent Application Publication
(10) Pub. No.: US 2007/0118860 A1
(43) Pub. Date: May 24, 2007

(54) Video advertising delivery system

(75) Inventors: Michael Siemens, Fort Collins, CO (US); Matt Siemens, Wildwood, MO (US); Tim Fetter, Florissant, MO (US)

Correspondence Address: PATTON BOGGS, 1660 LINCOLN ST, SUITE 2050, DENVER, CO, 80264, US

(73) Assignee: A4S Security, Inc., Loveland, CO (US)

(21) Appl. No.: 11/545,286

(22) Filed: Oct. 10, 2006

Related U.S. Application Data
(60) Provisional application No. 60/724,380, filed on Oct. 7, 2005.

(51) Int. Cl. H04N 7/18; G06F 13/00; G06F 7/00; B29C 45/00; H04N 5/445; G05B 15/00; G06F 3/00

(52) U.S. Cl. 725/75; 725/81; 725/42; 700/1; 700/200; 700/213

(57) ABSTRACT

A mobile video advertisement delivery system comprising: a vehicle locator system, a video advertisement storage system, a processor communicating with the vehicle locator system for determining a suitable time or place to display an advertisement, and a display communicating with the processor for displaying the advertisement at the suitable time or place. Preferably, the vehicle locator system includes a GPS system Preferably, the advertisement is stored at a location away from the vehicle and delivered via wireless or the advertisement may be stored on a storage medium, such as a hard disk, in the vehicle. Preferably, the system further includes a video surveillance system. Using the system, video advertisements maybe displayed on a public transportation vehicle, such as a bus, as the vehicle approaches an advertiser location.

### CROSS-REFERENCE TO RELATED APPLICATIONS

This Application is a Non-Provisional Application of Provisional (35 USC 119(e)) Application 60/724380 filed on Oct. 7, 2005. This Non-Provisional Application is timely filed in that the deadline for the filing date fell on a Saturday (Oct. 7, 2006) and followed by the Columbus Day Federal Holiday (Oct. 9, 2006), i.e., Oct. 10, 2006 is the next business day following the due date for filing the Non-Provisional Application.

### FIELD OF THE INVENTION

The invention in general relates to mobile video systems and more particularly to apparatus and methods for delivery of video advertisements via mobile systems.

### BACKGROUND OF THE INVENTION

Video systems are routinely located on moving vehicles, such as busses, streetcars, trolleys, trams, and trains. Usually, these video systems are associated with surveillance systems. Such systems cost money and, since transportation vehicles often run on thin budgets, they are not used as much as they could be, with detriment to the passengers, the transportation provider, and the public. Advertisements are also commonly located on such vehicles. However, the advertisements are seen so often by riders that they tend to blend into the background. Thus, they are not as effective as they might be otherwise. It would be highly useful if a way were found to make advertising more effective, and it would be even more useful if it could use the already-paid-for video system.

### BRIEF SUMMARY OF THE INVENTION

The present invention advances the art and helps to overcome the aforementioned problems by providing a mobile video advertisement delivery system comprising: a vehicle locator system; a video advertisement storage system; a processor communicating with the vehicle locator system for determining a suitable time or place to display an advertisement; and a display communicating with the processor for displaying the advertisement at the suitable time or place. Preferably, the vehicle locator system includes a GPS system. Preferably, the advertisement is stored at a location away from the vehicle and delivered via wireless. Preferably, the system further includes a video surveillance system.

The invention also provides a method of delivering advertisements, the method comprising: placing a video display in a vehicle; determining a proximity time when the vehicle will be in proximity to an advertiser location; and displaying an advertisement associated with the advertiser location for a time period associated with the proximity time. Preferably, the placing of the video display in a vehicle comprises placing the video display in a public transportation vehicle. Preferably, the displaying comprises displaying the advertisement for a time period prior to the vehicle arriving adjacent the advertiser location. Preferably, the displaying comprises displaying the advertisement for a time period while the vehicle is stopped at the advertiser location. Preferably, the method further comprises video recording the activity within the vehicle during the time period.

In another aspect, the invention provides a method of delivering advertisements, the method comprising: installing a video surveillance system in a vehicle; and using at least a portion of the video surveillance system to display advertising videos.

The above and other features and advantages of the present invention maybe better understood from a reading of the following description of the preferred exemplary embodiments of the invention taken in conjunction with the drawings in which:

### BRIEF DESCRIPTION OF THE DRAWINGS

FIG. 1 is a block diagram of an exemplary mobile video delivery system according to the invention; and

FIG. 2 is a flow chart illustrating an exemplary method for timely delivery of video advertisements.

### DETAILED DESCRIPTION OF THE INVENTION

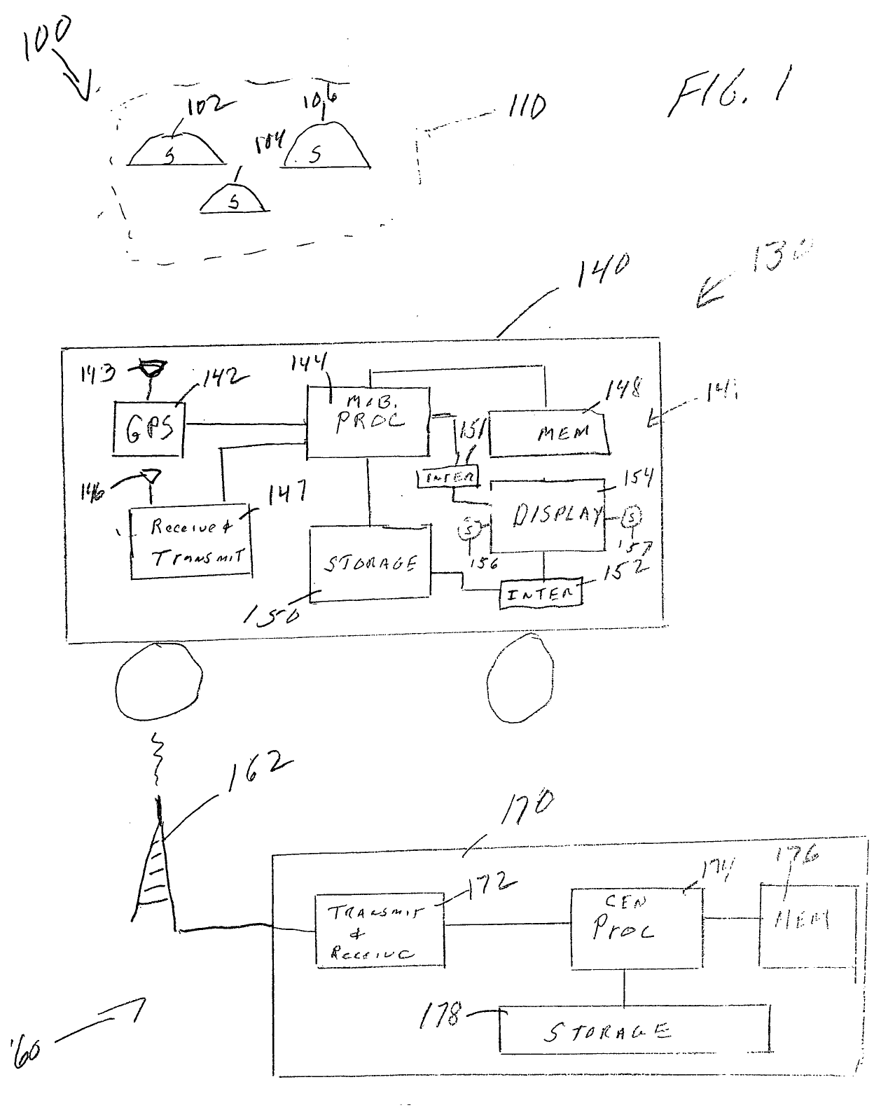

Herein, “video” preferably includes both a picture or visual display and the audio, but may include only the picture. FIG. 1 shows a block diagram of an exemplary mobile video advertisement delivery system (VADS) 100 according to the invention. System 100 includes three major parts, which may be separately provided by different entities: a location infrastructure 110, which preferably is a GPS satellite system, but may be a more local locator system; a mobile system 130; and a central, usually non-mobile, system 160. Locator infrastructure 110 preferably comprises a plurality of satellites 102, 104, and 106 as known in the art.

Mobile system 130 includes a vehicle 140, a microprocessor 144, a locator 142, an electronic memory 148, an electronic storage unit 150, a video system 141, and a receiver/transmitter 147. Locator 142 preferably is a GPS locator with antenna 143. Receiver/transmitter 147 includes an aerial 146, and video system 141 preferably comprises a display 154, speakers 156 and 157, and interfaces 151 and 152. Memory 148 and electronic storage unit 150 may comprise a single device, but preferably the memory 148 is a random access memory while storage unit 150 is a hard drive, a tape drive, or other mass storage unit. Only one of interfaces 151 and 152 maybe used in some embodiments, but two interfaces give the alternatives of delivering video via the microprocessor 144 or directly from mass storage unit 150.

Central system 160 includes a central processor 174, an electronic memory 176, an electronic storage unit 178, a transmit and receive unit 172, and an aerial 162. Again, memory 176 is preferably a RAM and storage unit 178 is preferably a hard drive, tape drive, or other mass storage unit, but they may be combined in a single memory or storage unit. Central system 160 is optional, as the entire video advertising display system may be in mobile vehicle 140.

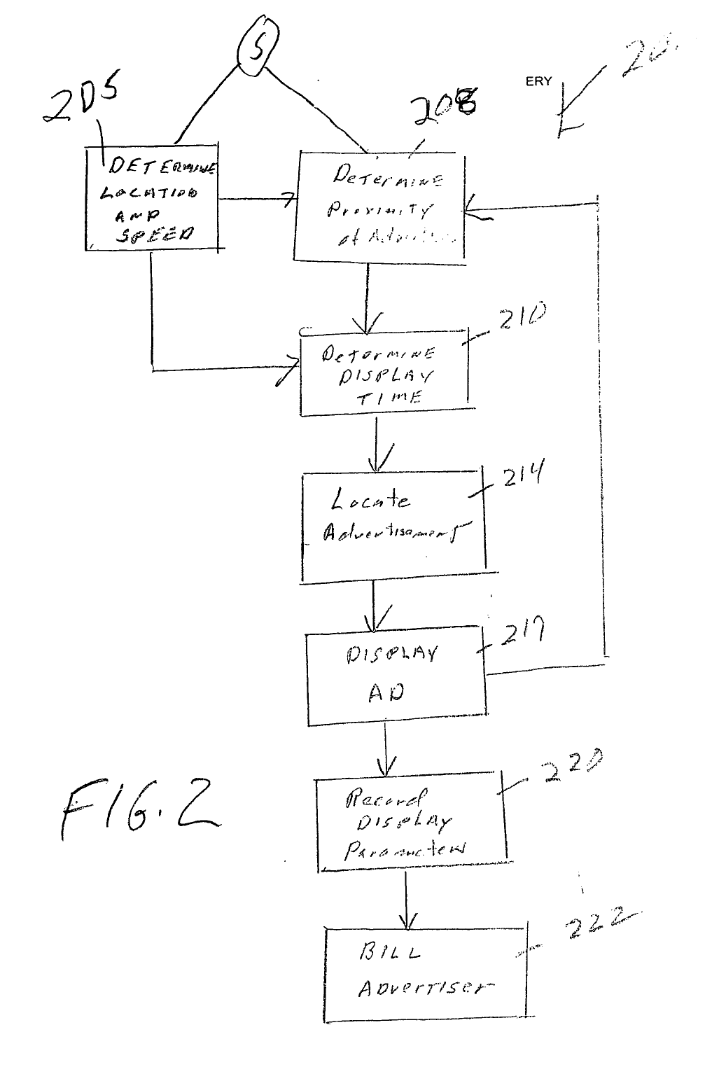

FIG. 2 is a flow chart illustrating an exemplary method for timely delivery of video advertisements. First, locator information from locator system 110 and 142 is used to determine the location and speed of the vehicle at 205. At 208, the location information and preferably also the speed information are used to determine the proximity of an advertiser, for example, an ice cream shop. A suitable time and/or place at which to display the advertisement is then determined at 210. This time and/or place will depend on the location of the vehicle, and usually also the speed of the vehicle, and usually is over a time range of minutes or seconds prior to the time the advertiser location is reached. For example, the ice cream advertisement may display for thirty seconds prior to the vehicle reaching the location or closest proximity to the ice cream shop. The suitable time and/or place determination may not include the actual determination of a time of day, or even a time period, but the delivery of the advertisement may simply be triggered by the proximity of an advertising target, and ended by the passing of the target, or the fact that the vehicle is no longer in proximity to the advertising target. The term “time” here relates primarily to the fact that the advertisement is delivered only for a certain time period and is not always on. The appropriate advertisement is located at 214. Generally, the advertisement is stored on mass storage system150 in the vehicle, but it maybe located on mass storage system 178 at the central office and delivered to the mobile system 130 via transmitter 172, receiver 147, and aerials 162 and 146. An Internet system with wireless access may also be used to deliver the advertisement. At 217, the advertisement is displayed at the appropriate time. The system then returns to 208 to deliver the next advertisement, and records the display at 220. The advertiser may then be billed at 222. Alternatively, the advertiser may pay a flat fee for a certain number of advertisement displays.

The system 100 is preferably incorporated into a surveillance system as described in United States Patent Publication No. No. 2003/0086000 published May 8, 2003 and entitled “Remote Surveillance System”, which publication is incorporated by reference to the same extent as though fully disclosed herein. Such surveillance systems usually run at a fraction of their capacity to manage video; thus, the video storage and control system of the surveillance system may be used to deliver the advertisements without loss of surveillance capacity.

The system according to the invention allows a public transportation company, for example, to target a captive audience with up-to-the-minute advertising and pay for its video security at the same time. The system permits the advertising to be presented at a critical buying juncture, that is, when the vehicle is in proximity to an advertiser location. Here, “proximity” means that the vehicle is within a predetermined distance of the advertiser location, which distance is such that a person in the audience can reach the location within a reasonably short time, preferably, twenty minutes, more preferably, ten minutes, and most preferably, five minutes. In the optimum situation, a person in the audience can reach the advertiser location within one minute.

The system also permits the advertisement to be played when the vehicle is adjacent to the advertiser location. Here, “adjacent” means that the vehicle is at a point on a street or other vehicle path at which a vehicle on the street or other vehicle path is passing the advertiser location.

The system according to the invention also permits the user to make good use of its surveillance system. Using broadcast quality, full-motion video, and GPS technology in a typical surveillance system, such as the ShiftWatch® system, the user can provide local advertisers with geo-targeted ads. Meanwhile, the user generates revenue and pays for its video security system at the same time!

The average transit rider spends 1½ hours a day commuting to and from work This captive audience is a valuable asset to advertisers. With geo-targeting, the VADS enables advertisers to promote their products as the transit vehicle nears their store or retail outlet selling their products.

The system can use revenue sharing models, which vary by ridership, demographics, and number of advertising “impressions.” The VADS developer can work with the user to define a program that meets the user's needs.

Some features of the system according to the invention include its ability to generate revenue the first day. It provides advertisements in broadcast quality, full-motion, high resolution video. It permits targeting a captive audience, which results in more valuable advertising. It uses GPS technology to geo-target advertising, that is, target the advertising to a specific location. It permits either video or audio advertising or both. It also provides the ability to update advertising messages frequently to increase product awareness.

There has been described a video delivery system that timely delivers video advertisements in mobile environments. It should be understood that the particular embodiments shown in the drawings and described within this specification are for purposes of example and should not be construed to limit the invention, which will be described in the claims below. Further, it is evident that those skilled in the art may now make numerous uses and modifications of the specific embodiments described, without departing from the inventive concepts. It is also evident that the methods recited may, in many instances, be performed in a different order, or equivalent structures and processes may be substituted for the various structures and processes described. Consequently, the invention is to be construed as embracing each and every novel feature and novel combination of features present in and/or possessed by the invention herein described.

What is claimed as new and desired to be protected by Letters Patent of the United States is:

1. A mobile video advertisement delivery system comprising:
a vehicle locator system;
a video advertisement storage system;
a processor communicating with said vehicle locator system for determining a suitable time or place to display an advertisement; and
a display communicating with said processor for displaying said advertisement at said suitable time or place.

2. A mobile video advertisement delivery system as in claim 1 wherein said vehicle locator system include a GPS system.

3. A mobile video advertising delivery system as in claim 1 wherein said advertisement is stored on a mass storage unit on said vehicle.

4. A mobile video advertisement delivery system as in claim 1 wherein said advertisement is stored at a location away from said vehicle and delivered via wireless.

5. A mobile advertisement delivery system as in claim 1 wherein said system further includes a video surveillance system.

6. A method of delivering advertisements, said method comprising:
placing a video display in a vehicle;
determining a proximity time when said vehicle will be in proximity to an advertiser location; and
displaying an advertisement associated with said advertiser location for a time period associated with said proximity time.

7. A method as in claim 6 wherein said placing said video display in a vehicle comprises placing said video display in a public transportation vehicle.

8. A method as in claim 6 wherein said displaying comprises displaying said advertisement for a time period prior to said vehicle arriving adjacent said advertiser location.

9. A method as in claim 6 wherein said displaying comprises displaying said advertisement for a time period while said vehicle is stopped at said advertiser location.

10. A method as in claim 6 and further comprising video recording the activity within said vehicle during said time period.

11. A method of delivering advertisements, said method comprising:
installing a video surveillance system in a vehicle; and
using at least a portion of said video surveillance system to display advertising videos.
